(19) United States
(12) Patent Application Publication
(10) Pub. No.: US 2020/0323175 A1
(43) Pub. Date: Oct. 15, 2020

(54) BAFFLE ASSEMBLIES FOR POLE

(71) Applicant: Allan Wendling, New Lothrop, MI (US)

(72) Inventor: Allan Wendling, New Lothrop, MI (US)

(21) Appl. No.: 16/796,125

(22) Filed: Feb. 20, 2020

Related U.S. Application Data
(63) Continuation-in-part of application No. 16/382,780, filed on Apr. 12, 2019.

(51) Int. Cl. A01K 39/01

(52) U.S. Cl. CPC A01K 39/0113

(57) ABSTRACT

A baffle assembly for a pole includes a clamping structure adapted to be positioned about a pole. The clamping structure includes a plurality of laterally spaced mounting hooks removably joined along the longitudinal axis. The plurality of laterally spaced mounting hooks extends from a proximal end to a distal end defining a length of the clamping structure. A mounting strap includes a first end attached to the proximal end of the clamping structure. The mounting strap extends to a second end and includes a fastener formed thereon. A bell housing includes opposing open ends. The bell housing is positioned about the pole and about the clamping structure wherein the bell housing is supported by the mounting hooks. The length of the clamping structure is adjusted by removal of selected mounting hooks of the plurality of laterally spaced mounting hooks from the distal end.

### CROSS-REFERENCE TO RELATED APPLICATION

This application is a continuation-in-part application which claims priority to co-pending U.S. patent application Ser. No. 16/382,780, filed Apr. 12, 2019, for “Baffle Assembly For Pole,” which is hereby incorporated by reference in its entirety including the drawings.

### TECHNICAL FIELD

The invention relates to baffles for a pole and, more specifically, baffles for a pole protected against damage caused by an animal.

### BACKGROUND

Baffles may be utilized on a pole to prevent animals such as squirrels from climbing the pole to gain access to a birdfeeder. There are many prior art birdfeeders that include baffles in their design. However, the known baffles are typically designed for mounting in a specific manner, such as on a pole of a specified diameter.

It is therefore desirable to have a baffle that may be utilized on poles of various diameters and that is easily mounted to a pole by a user.

### SUMMARY

In one aspect, there is disclosed a baffle assembly for a pole including a clamping structure adapted to be positioned about a pole. The clamping structure includes a plurality of laterally spaced mounting hooks removably joined along a longitudinal axis. The plurality of laterally spaced mounting hooks extends from a proximal end of the clamping structure to a distal end of the clamping structure defining a length of the clamping structure. The baffle assembly includes a mounting strap including a first end attached to the proximal end of the clamping structure. The mounting strap extends to a second end including a fastener formed thereon. The baffle assembly further includes a bell housing including a first open end and an opposing second open end. The bell housing is adapted to be positioned about a pole and about the clamping structure. The bell housing includes a first half, a second half, and a plate extending from an inner surface of each of the first half and the second half. The bell housing is supported by the mounting hooks when the clamping structure and the bell housing are positioned about a pole, and the length of the clamping structure is adjusted by removal of selected mounting hooks of the plurality of laterally spaced mounting hooks from the distal end.

In another aspect, there is disclosed a baffle assembly for a pole including a clamping structure adapted to be positioned about a pole. The clamping structure includes a plurality of laterally spaced mounting hooks. The mounting hooks includes a web material formed along a longitudinal axis between adjacent mounting hooks of the plurality of laterally spaced mounting hooks removably joining the adjacent mounting hooks along the longitudinal axis. The plurality of laterally spaced mounting hooks extend from a proximal end of the clamping structure to a distal end of the clamping structure defining a length of the clamping structure. The baffle assembly further includes a mounting strap including a first end attached to the proximal end of the clamping structure. The mounting strap extends to a second end including a fastener formed thereon. The baffle assembly further includes a bell housing including a first half and a second half. The first half and the second half each have a proximal end defining a first open end, a distal end defining an opposing second open end, and a U-shaped metal plate extending along the distal end of each of the first half and the second half of the bell housing. The bell housing is adapted to be positioned about a pole and about the clamping structure. The bell housing is supported by the mounting hooks when the clamping structure and the bell housing are positioned about a pole, and the length of the clamping structure is adjusted by removal of selected mounting hooks of the plurality of laterally spaced mounting hooks from the distal end of the clamping structure.

In a further aspect, there is disclosed a baffle assembly for a pole including a clamping structure adapted to be positioned about a pole. The clamping structure includes a plurality of laterally spaced mounting hooks. Each of the plurality of laterally spaced mounting hooks including a shank extend to a hooked body which includes a mounting surface extending to an angled face. The plurality of laterally spaced mounting hooks are removably joined along a longitudinal axis. The plurality of laterally spaced mounting hooks extend from a proximal end of the clamping structure to a distal end of the clamping structure defining a length of the clamping structure. The baffle assembly further includes a mounting strap including a first end attached to the proximal end of the clamping structure. The mounting strap extends to a second end including a fastener formed thereon. The baffle assembly further including a bell housing including a first open end and an opposing second open end. The bell housing includes a first half and a second half hingedly attached to the first half. The bell housing is adapted to be positioned about a pole and about the clamping structure. The bell housing is supported by the mounting hooks when the clamping structure and the bell housing are positioned about a pole and the length of the clamping structure is adjusted by removal of selected mounting hooks of the plurality of laterally spaced mounting hooks from the distal end.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of an example clamping structure;

FIG. 2 schematically depicts a front view of the clamping structure;

FIG. 3 schematically depicts an end view of the clamping structure;

FIG. 4 schematically depicts an opposite end view of the clamping structure;

FIG. 5 schematically depicts a top view of the clamping structure;

FIG. 6 schematically depicts an exploded perspective view of the clamping structure, a pole, and an example bell housing in a disassembled state;

FIG. 7 schematically depicts an exploded perspective view of the clamping structure, the pole, and the bell housing in a partially assembled state;

FIG. 8 schematically depicts a perspective view of the clamping structure, the pole, and the bell housing in an assembled state;

FIG. 9 schematically depicts a perspective view of an example bell housing in a disassembled state;

FIG. 10 schematically depicts a perspective view of an example bell housing in a partially assembled state; and

FIG. 11 schematically depicts a perspective view of an example bell housing in a partially assembled state.

### DETAILED DESCRIPTION

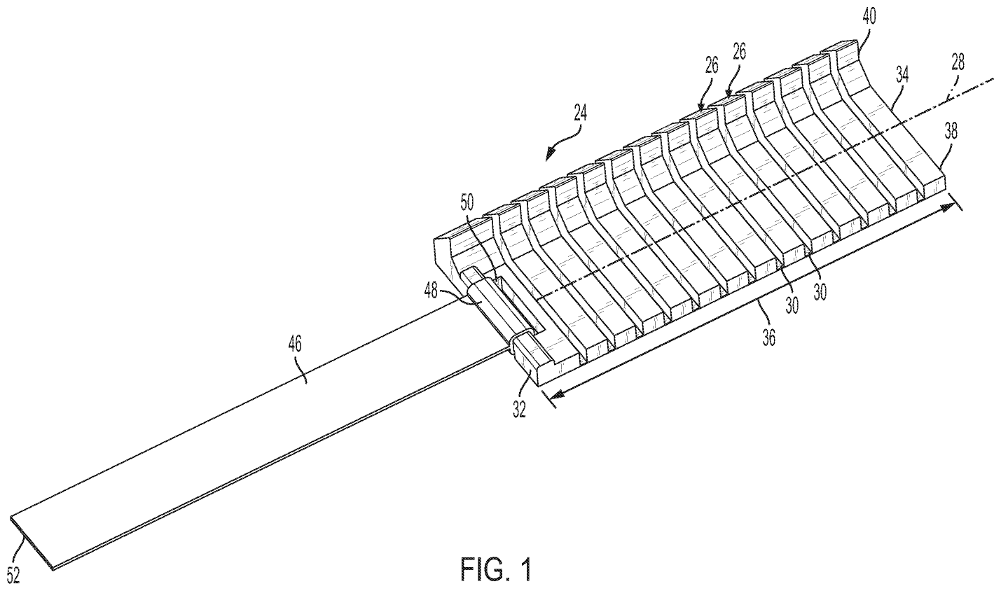

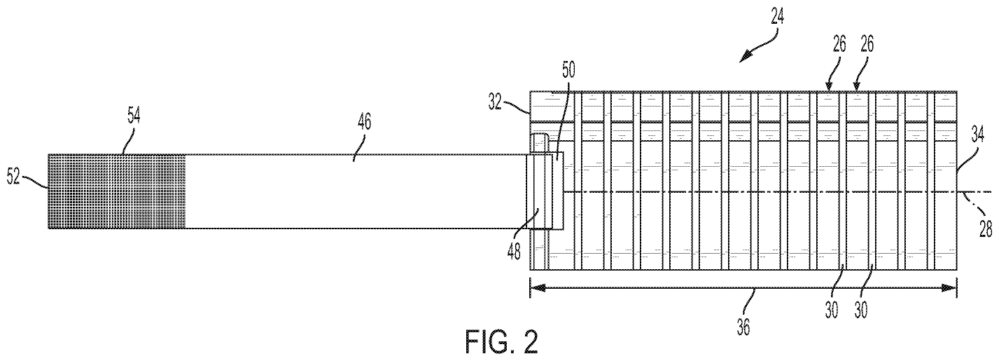

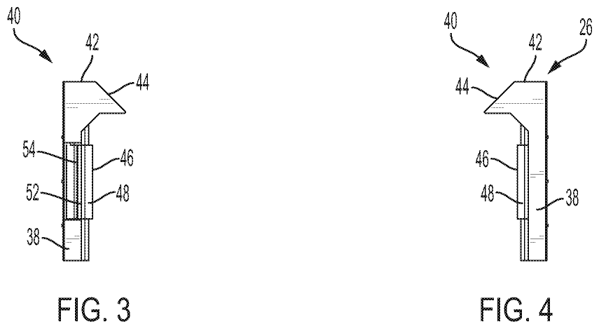

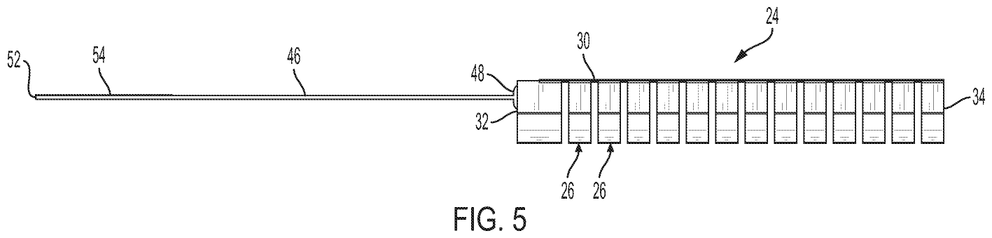

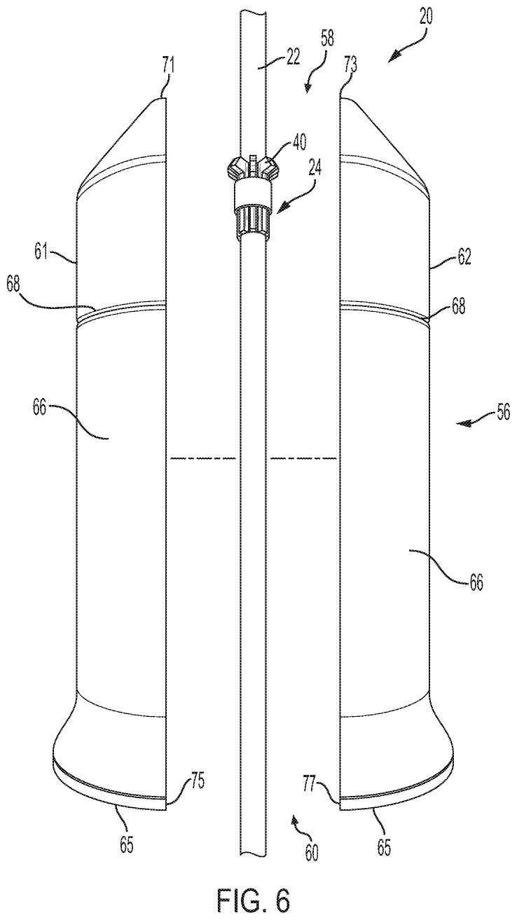

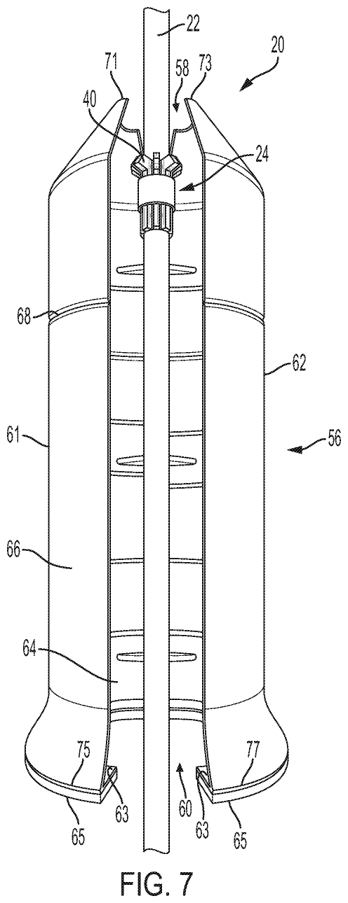

Referring to FIGS. 6 and 7, there is shown a baffle assembly 20 for a pole 22. The baffle assembly 20 includes a clamping structure 24 adapted to be positioned about the pole 22. As shown in FIGS. 1-5, the clamping structure 24 includes a plurality of laterally spaced mounting hooks 26 removably joined along a longitudinal axis 28. In one aspect, a web material 30 is formed along the longitudinal axis 28 between adjacent mounting hooks 26 of the plurality of laterally spaced mounting hooks 26 joining the adjacent mounting hooks 26. The plurality of laterally spaced mounting hooks 26 extend from a proximal end 32 of the clamping structure 24 to a distal end 34 of the clamping structure 24 defining a length 36 of the clamping structure 24. The length 36 of the clamping structure 24 may be adjusted by removal of selected mounting hooks 26 of the plurality of laterally spaced mounting hooks 26 from the distal end 34, as will be discussed in more detail below. The plurality of laterally spaced mounting hooks 26 may be formed of any suitable material such as, for example, an elastomer, a rubber, a plastic, or the like.

Each of the plurality of laterally spaced mounting hooks 26 include a shank 38 extending to a hooked body 40. The hooked body 40 includes a mounting surface 42 extending to an angled face 44.

A mounting strap 46 includes a first end 48 attached to the proximal end 32 of the clamping structure 24. In one aspect, the mounting hook 26 at the proximal end 32 includes an attachment slot 50 formed therein for attaching the first end 48 of the mounting strap 46. The mounting strap 46 extends to a second end 52 that includes a fastener 54 formed thereon. In one aspect, the fastener 54 is a hook and loop fastener that removably attaches to a portion of the mounting strap 46.

Referring now to FIGS. 6-8, a bell housing 56 includes opposing open ends 58, 60. The open end 58 of the bell housing 56 is defined by a proximal end 71 of the first half 61 and a proximal end 73 of the second half 62. The open end 60 of the bell housing 56 is defined by a distal end 75 of the first half 61 and a distal end 77 of the second half 62. The open end 58 of the bell housing 56 proximate the clamping structure 24 has an opening size less than a length of the hooked body 40 of each mounting hook 26. The bell housing 56 is positioned about the pole 22 and about the clamping structure 24 such that the bell housing 56 is supported by the mounting hooks 26 at the open end 58. The bell housing 56 may be formed of a rigid plastic material such as polypropylene. In one aspect, the bell housing 56 includes a two-piece housing including a first half 61 and a second half 62 that may be joined together about the pole 22. In one aspect, the first half 61 and the second half 62 may include bayonet pins and slots (not shown) formed on the edges to align the first half 61 and the second half 62 when assembled. As shown in FIG. 7, a metal ring 65 may be provided at the open end 60 of the bell housing 56 opposite the clamping structure 24. The metal ring 65 may be provided on an underside of an inwardly directed flange 63 extending from the distal ends 75, 77 and toward the pole 22 along the circumference of the bell housing 56 defined by the distal ends 75, 77 thereof. The metal ring 65 prevents damage to the bell housing 56 by chewing from an animal.

The bell housing 56 includes separated inner and outer surfaces 64, 66. The outer surface 66 includes a groove 68 formed therein about a circumference of the bell housing 56. A slot 70 is formed in the groove 68. A snap ring 72 is disposed in the groove 68 and includes a first attachment end 74 engaging one end of the slot 70 and a second attachment end 76 engaging an opposing end of the slot 70. The snap ring 72 compresses the first half 61 and the second half 62 together. In some embodiments, a hook and loop strap (not shown) may be provided within the groove 68 in order to secure the first half 61 and the second half 62 to one another.

In use, to assemble the baffle assembly 20, a user may wrap the clamping structure 24 about the pole 22 at a desired height along the pole 22. The clamping structure 24 is wrapped about the pole 22 such that the shanks 38 of the laterally spaced mounting hooks 26 abut the pole 22 with the hooked body 40 facing away from the pole 22, as shown in FIGS. 6-7. The user may adjust the length of the clamping structure 24 by removal of selected mounting hooks 26 of the plurality of laterally spaced mounting hooks 26 from the distal end 34 of the web material 30. Thus, the clamping structure 24 may be used with various diameter poles. In this manner, the mounting hooks 26 will be spaced about the circumference of various diameter poles 22. In one aspect, the user may separate the selected mounting hooks 26 along the web material 30 between adjacent mounting hooks 26.

After the clamping structure 24 is wrapped about the pole 22 with the desired length, the mounting strap 46 is wrapped about the plurality of laterally spaced mounting hooks 26. The mounting strap 46 is secured to itself using the fastener 54 as described above. The mounting hooks 26 are now secured to the pole 22 at a desired height.

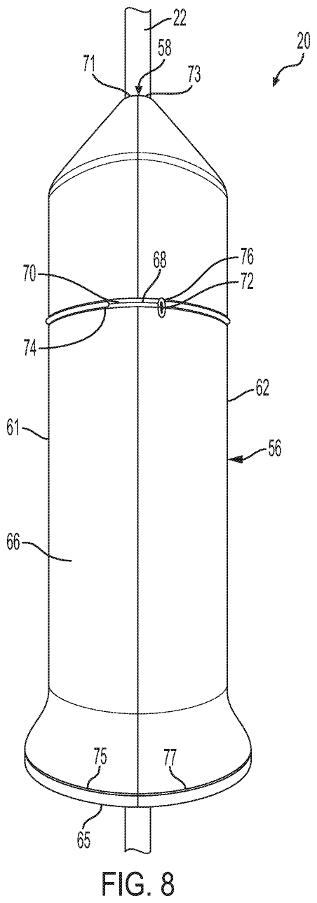

Next, the bell housing 56 including the first half 61 and the second half 62 are joined together about the pole 22, such that the inner surface 64 of the bell housing 56 sits on the mounting hooks 26 proximate the open end 58 of the bell housing 56. The snap ring 72 is positioned in the groove 68 such that the first attachment end 74 engages one end of the slot 70 and a second attachment end 76 engages an opposing end of the slot 70. The snap ring 72 compresses the first half 61 and the second half 62 together as shown in FIG. 8.

The contact of the mounting hooks 26 is variable with the inner surface 64 of the bell housing 56 due to the structure of the hooked body 40 including a mounting surface 42 extending to the angled face 44. The angled face 44 allows the bell housing 56 to wobble when an animal attempts to climb on the baffle assembly 20.

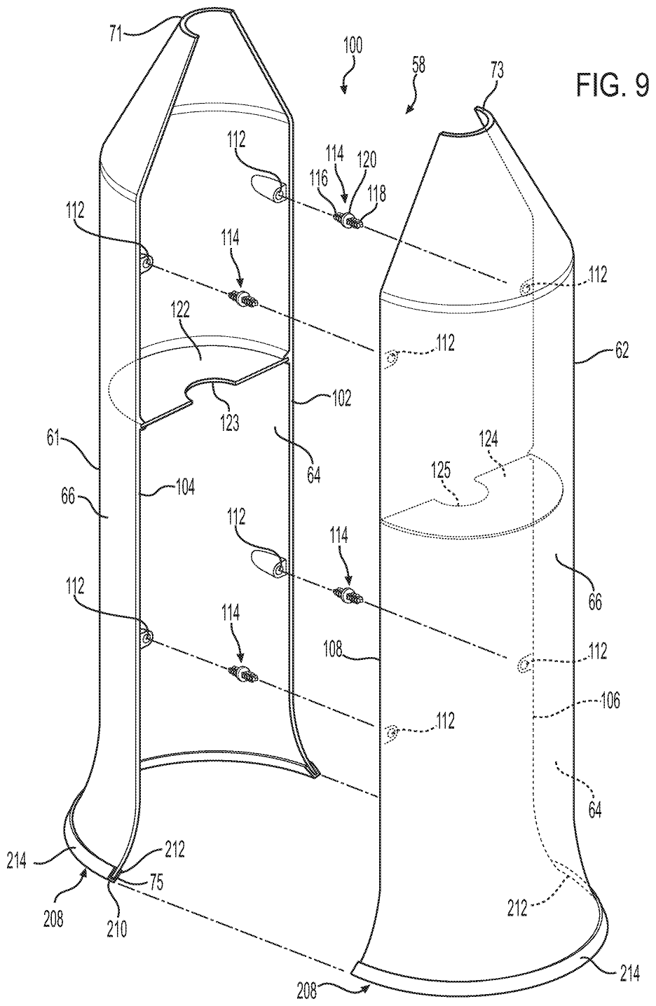

As shown in FIG. 9, another embodiment of a bell housing 100 is illustrated. It should be appreciated that the bell housing 100 is substantially similar to the bell housing 56 and, therefore, like structure is indicated with like reference numerals. As shown, the bell housing 100 includes the first half 61 and the second half 62. In this embodiment, the first half 61 and the second half 62 are completely separable and press-fitted to one another to be secured. Specifically, the first half 61 includes a pair of edges 102, 104 and the second half 62 includes a pair of edges 106, 108. In some embodiments, each of the edges 102, 104 of the first half 61 and the edges 106, 108 of the second half 62 has at least one hole 112 formed therein for receiving and securing a double-ended push pin 114 such as, for example, a double-ended fir tree pin sold by JET PRESS. As such, the push pin 114 includes a first end 116 and a second end 118 having a plurality of flexible ribs for engaging the material defining the holes 112 in the first half 61 and the second half 62. The push pin 114 includes a plate 120 separating the first end 116 and the second end 118 of the push pin 114 and to prevent the push pin 114 from over extending into the holes 112. As shown, the bell housing 100 includes eight holes 112, with four holes 112 on each of the first half 61 and the second half 62, for receiving a total of four push pins 114.

In some embodiments, the bell housing 100 further includes a pair of semi-circular plates 122, 124 provided on and extending along the inner surface 64 of the bell housing 100. Specifically, the first semi-circular plate 122 is provided on the first half 61 and the second semi-circular plate 124 is provided on the second half 62. The semi-circular plates 122, 124 are secured to the bell housing 200 by any suitable means such as by using an adhesive, mechanical fasteners, welding, or the like. In some embodiments, the semi-circular plates 122, 124 are provided closer to the open end 58 than to the open end 60. When the first half 61 and the second half 62 of the bell housing 100 is in the assembled form, an inner circumference 123 of the semi-circular plate 122 cooperates with an inner circumference 125 of the other semi-circular plate 124 to form an opening sized to substantially fit the pole 22 (FIG. 7) and is substantially equal to the open end 58. It should be appreciated that the semi-circular plates 122, 124 prevent animals from climbing through the open end 60 and damaging the clamping structure 24 (FIG. 7) proximate the opposite open end 58.

Contrary to the metal ring 65 provided on the flange 63 at the open end 60 of the bell housing 56, which extends inwardly toward the pole 22, the bell housing 200 includes a metal plate 208 having a U-shaped cross-section provided at the open end 60 of each of the first half 61 and the second half 62 and conforming to the shape of the distal ends 75, 77 of the bell housing 100. More particularly, the metal plate 208 includes a base 210 and a pair of legs 212, 214 extending substantially perpendicular to the base 210. The leg 212 extends along the inner surface 64 of the bell housing 200 and the leg 214 extends along the outer surface 66 of the bell housing 200 toward the opposite open end 58. The metal plate 208 is secured to the bell housing 200 by any suitable means such as by using an adhesive, mechanical fasteners, welding, or the like. It should be appreciated that the metal plate 208 prevents animals from damaging, such as by chewing, the bell housing 100 proximate the open end 60.

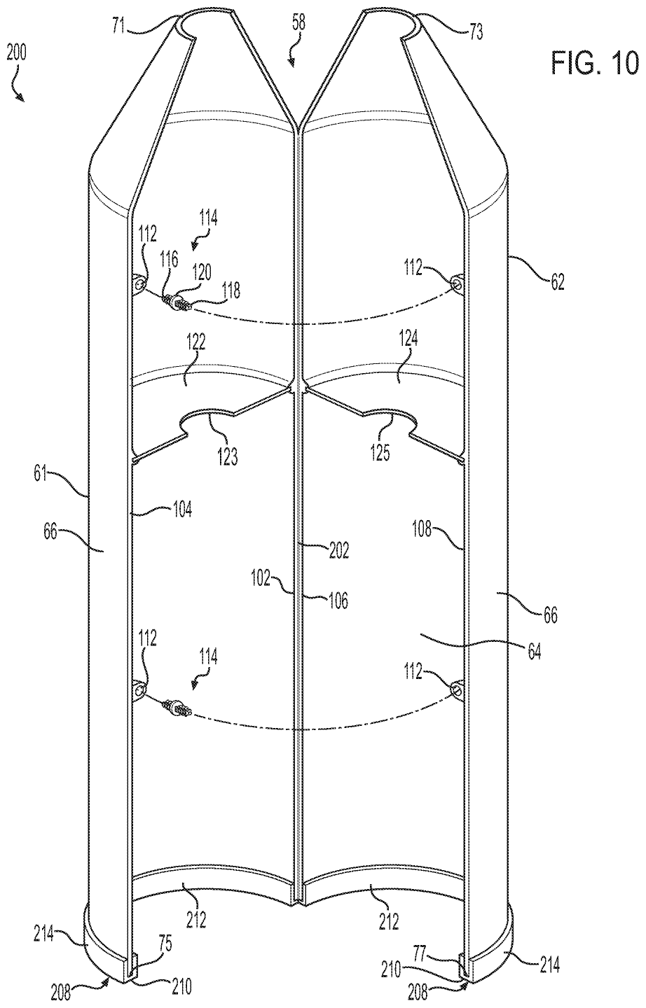

As shown in FIG. 10, another embodiment of a bell housing 200 is illustrated. It should be appreciated that the bell housing 200 is substantially similar to the bell housing 56 and the bell housing 100 and, thus, like structure is indicated with like reference numerals. As shown, the bell housing 200 includes the first half 61 and the second half 62 hingedly attached to one another at adjacent edges 102, 106 by a hinge 202. The hinge 202 may extend the entire length of the edges 102, 106 of the first half 61 and the second half 62 or a plurality of individual hinge pieces (not shown) may be provided. It should be appreciated that by provided the hinge 202 extending the entire length of the bell housing 200, the hinge 202 may prevent gaps from being formed between the first half 61 and the second half 62, which may result in wearing of the interior of the bell housing 200. As such, only four holes 112 are provided, two holes 112 on each of the first half 61 and the second half 62 for securing the edge 104 of the first half 61 to the edge 108 of the second half 62 with only a pair of push pins 114.

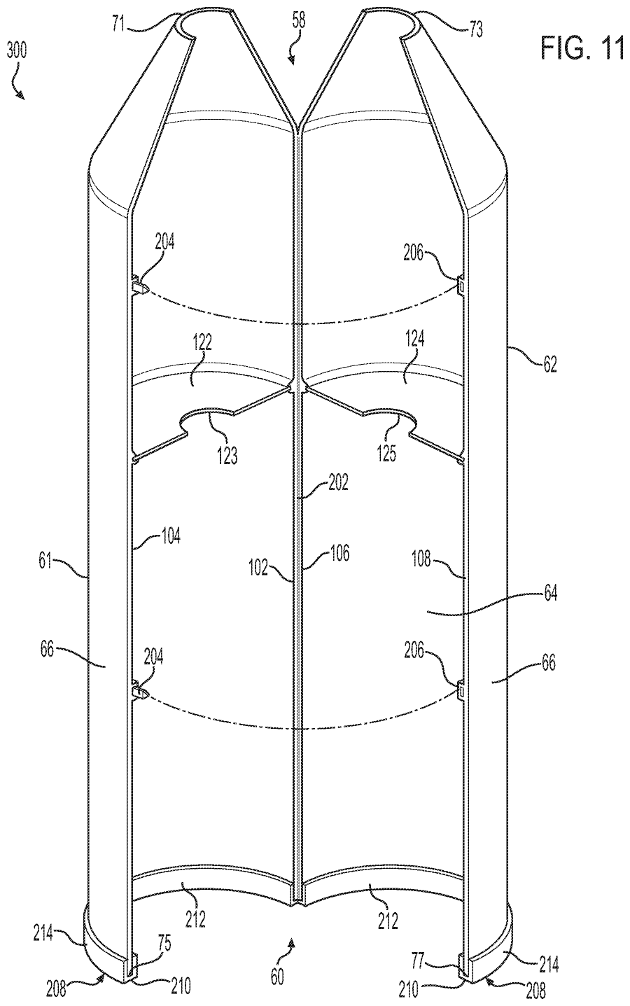

As shown in FIG. 11, another embodiment of a bell housing 300 is illustrated. It should be appreciated that the bell housing 300 is substantially similar to the bell housing 56, the bell housing 100, and the bell housing 200 and, thus, like structure is indicated with like reference numerals. The bell housing 300 includes at least one tab 204 provided on either the edge 104 of the first half 61 or the edge 108 of the second half 62 and at least one receiver 206 provided on the other of the edge 104 of the first half 61 and the edge 108 of the second half 62. The receiver 206 is dimensioned to receive the tab 204 and lock the first half 61 and the second half 62 together until the tab 204 is released from the receiver 206. As shown, a pair of tabs 204 are provided on the edge 104 of the first half 61 and a pair of receivers 206 are provided on the edge 108 of the second half 62. When the first half 61 and the second half 62 are rotated toward one another about the hinge 202, the tabs 204 engage the receivers 206 and lock the first half 61 and the second half 62 together.

It should be appreciated that features described in various embodiments, such as the groove 68, the holes 112 and the push pins 114, the semi-circular plates 122, 124, the hinge 202 attaching the first half 61 and the second half 62, the tabs 204 and the receivers 206, the geometry of the open end 60 of the first half 61 and the second half 62, and the metal plates 208 provided at the open end 60, are not exclusive of one another and may be combined in any suitable manner on any of the bell housings described herein. As a nonlimiting example, a bell housing may be provided including either the openings and push pins or the tabs and the receivers, in combination with a groove, a pair of semi-circular plates, and an upstanding metal plate at an open end of the bell housing opposite the clamping structure.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A baffle assembly for a pole comprising:
a clamping structure adapted to be positioned about a pole, the clamping structure including a plurality of laterally spaced mounting hooks removably joined along a longitudinal axis, the plurality of laterally spaced mounting hooks extending from a proximal end of the clamping structure to a distal end of the clamping structure defining a length of the clamping structure;
a mounting strap including a first end attached to the proximal end of the clamping structure, the mounting strap extending to a second end including a fastener formed thereon; and
a bell housing including a first open end and an opposing second open end, the bell housing adapted to be positioned about the pole and about the clamping structure, the bell housing including a first half, a second half, and a plate extending from an inner surface of each of the first half and the second half,
wherein the bell housing is supported by the mounting hooks when the clamping structure and the bell housing are positioned about a pole,
wherein the length of the clamping structure is adjusted by removal of selected mounting hooks of the plurality of laterally spaced mounting hooks from the distal end.

2. The baffle assembly of claim 1, wherein the clamping structure includes a web material formed along the longitudinal axis between adjacent mounting hooks of the plurality of laterally spaced mounting hooks joining the adjacent mounting hooks.

3. The baffle assembly of claim 1, wherein each of the plurality of laterally spaced mounting hooks include a shank extending to a hooked body.

4. The baffle assembly of claim 3, wherein the hooked body includes a mounting surface extending to an angled face.

5. The baffle assembly of claim 1, wherein the plurality of laterally spaced mounting hooks is formed of an elastomer.

6. The baffle assembly of claim 1, wherein the fastener is a hook and loop fastener.

7. The baffle assembly of claim 1, wherein the bell housing includes separated inner and outer surfaces, the outer surface including a groove formed therein about a circumference of the bell housing.

8. The baffle assembly of claim 3, wherein the first open end of the bell housing is proximate the clamping structure and has an opening size less than a length of the hooked body when the clamping structure and the bell housing are positioned about a pole.

9. The baffle assembly of claim 1, wherein a first edge of the first half of the bell housing is hingedly secured to an opposite first edge of the second half of the bell housing.

10. The baffle assembly of claim 9, wherein a second edge of the first half of the bell housing and a second edge of the second half of the bell housing each include at least one opening for receiving an associated end of a push pin for securing the second edge of the first half to the second edge of the second half.

11. The baffle assembly of claim 1, further comprising a U-shaped metal plate extending along a distal end of each of the first half and the second half of the bell housing, the distal end of each of the first half and the second half defining the second open end of the bell housing opposite the clamping structure.

12. A baffle assembly for a pole comprising:
a clamping structure adapted to be positioned about a pole, the clamping structure including a plurality of laterally spaced mounting hooks, the mounting hooks including a web material formed along a longitudinal axis between adjacent mounting hooks of the plurality of laterally spaced mounting hooks removably joining the adjacent mounting hooks along the longitudinal axis, the plurality of laterally spaced mounting hooks extending from a proximal end of the clamping structure to a distal end of the clamping structure defining a length of the clamping structure;
a mounting strap including a first end attached to the proximal end of the clamping structure, the mounting strap extending to a second end including a fastener formed thereon; and
a bell housing including a first half and a second half, the first half and the second half each having a proximal end defining a first open end, a distal end defining an opposing second open end, and a U-shaped metal plate extending along the distal end of each of the first half and the second half of the bell housing, the bell housing adapted to be positioned about a pole and about the clamping structure,
wherein the bell housing is supported by the mounting hooks when the clamping structure and the bell housing are positioned about a pole,
wherein the length of the clamping structure is adjusted by removal of selected mounting hooks of the plurality of laterally spaced mounting hooks from the distal end of the clamping structure.

13. The baffle assembly of claim 12, wherein the plurality of laterally spaced mounting hooks is formed of an elastomer.

14. The baffle assembly of claim 12, wherein the fastener is a hook and loop fastener.

15. The baffle assembly of claim 12, wherein the first half and the second half of the bell housing are hingedly attached to one another.

16. The baffle assembly of claim 12, wherein the bell housing includes separated inner and outer surfaces, the outer surface including a groove formed therein about a circumference of the bell housing.

17. The baffle assembly of claim 12, wherein each of the plurality of laterally spaced mounting hooks include a shank extending to a hooked body.

18. The baffle assembly of claim 17, wherein the hooked body includes a mounting surface extending to an angled face.

19. A baffle assembly for a pole comprising:
a clamping structure adapted to be positioned about a pole, the clamping structure including a plurality of laterally spaced mounting hooks, each of the plurality of laterally spaced mounting hooks including a shank extending to a hooked body which includes a mounting surface extending to an angled face, the plurality of laterally spaced mounting hooks removably joined along a longitudinal axis, the plurality of laterally spaced mounting hooks extending from a proximal end of the clamping structure to a distal end of the clamping structure defining a length of the clamping structure;
a mounting strap including a first end attached to the proximal end of the clamping structure, the mounting strap extending to a second end including a fastener formed thereon; and
a bell housing including a first open end and an opposing second open end, the bell housing including a first half and a second half hingedly attached to the first half, the bell housing adapted to be positioned about a pole and about the clamping structure,
wherein the bell housing is supported by the mounting hooks when the clamping structure and the bell housing are positioned about a pole,
wherein the length of the clamping structure is adjusted by removal of selected mounting hooks of the plurality of laterally spaced mounting hooks from the distal end.

20. The baffle assembly of claim 19, wherein the clamping structure includes a web material formed along the longitudinal axis between adjacent mounting hooks of the plurality of laterally spaced mounting hooks joining the adjacent mounting hooks.
